(19) United States
(12) Patent Application Publication
(10) Pub. No.: US 2025/0347148 A1
(43) Pub. Date: Nov. 13, 2025

(54) COMPACT NEAR-FIELD COMMUNICATION AND MANUAL KEY HOUSING

(71) Applicant: GM Global Technology Operations LLC, Detroit, MI (US)

(72) Inventor: Paul Louis Mullin, Waterford Twp, MI (US)

(21) Appl. No.: 18/660,898

(22) Filed: May 10, 2024

(51) Int. Cl. E05B 19/00

(52) U.S. Cl. CPC E05B 19/00

(57) ABSTRACT

A near-field communication card and key system includes a near-field communication (NFC) card having a chip positioned on or embedded within a face of the NFC card. An L-shaped recess is created in the face of the NFC card. An L-shaped physical grooved key is provided for the NFC card releasably and frictionally retaining the physical grooved key in the recess. The physical grooved key includes: a key portion having a first width equaling a first portion width of a first portion of the recess; and a manual grip portion having a second width equaling a second portion width of a second portion of the recess. Data of the NFC card is saved in and transmitted from the chip using a wireless transmission path to a vehicle.

### INTRODUCTION

The present disclosure relates to near field communication (NFC) cards used in vehicle access control situations.

Access may be provided to a vehicle when electrical power is not available by use of a mechanical or physical key which a vehicle user normally keeps separate from or is stored in a key fob. The physical key may be used by insertion into a vehicle door lock to open the vehicle door. In other scenarios, the physical key may also be used to start the vehicle.

Remote access to open a vehicle may also be provided by the availability of a near-field communication (NFC) card retained by a vehicle user, which provides communication with the vehicle when vehicle power is available.

Thus, while current systems and methods to access vehicles either remotely or physically achieve their intended purpose, there is a need for a new and improved system and method to access vehicles when vehicle electrical power is not available.

### SUMMARY

According to several aspects, a near-field communication card and key system includes a near-field communication (NFC) card having a chip positioned on or embedded within a face of the NFC card. A recess is created in the face of the NFC card. A physical grooved key is provided for the NFC card having: a manual grip portion frictionally and releasably received within the recess; and a key portion having a grooved segment defining a key geometry adapted to engage and lock or unlock a vehicle door lock of a vehicle, the key portion frictionally and releasably received within the recess.

In another aspect of the present disclosure, the recess is L-shaped, with a first portion having a first width W₁ and a second portion having a second width W₂; and wherein the first width W₁ is substantially equal to the second width W₂.

In another aspect of the present disclosure, a concave-shaped slot is positioned proximate to a free-end of the second portion.

In another aspect of the present disclosure, an aperture is provided proximate to a free-end of the second portion, the aperture extending through a thickness of the NFC card.

In another aspect of the present disclosure, a depth of the recess is less than a thickness of the NFC card, and a substantially planar inner surface is created for an extent of the recess, including the first portion and the second portion.

In another aspect of the present disclosure, the physical grooved key includes a manual grip portion having a width W₃ substantially equaling the first width W₁ of the first portion of the recess, having the manual grip portion frictionally and releasably received within the first portion of the recess.

In another aspect of the present disclosure, the physical grooved key includes a key portion having a width W₄, substantially equaling the second width W₂ of the second portion of the recess, the key portion frictionally and releasably received within the second portion of the recess.

In another aspect of the present disclosure, the grooved segment defines a key geometry adapted to engage and lock or unlock a vehicle door lock or to engage and operate a start feature of a vehicle.

In another aspect of the present disclosure, the key portion is oriented substantially 90 degrees with respect to the manual grip portion together defining an L-shape, the key portion and the manual grip portion having an equivalent thickness, the thickness substantially equaling a depth of the recess, and the recess having an L-shape matching the L-shape of the key portion and the manual grip portion.

In another aspect of the present disclosure, data of the NFC card is saved in and transmitted from the chip using a wireless transmission path to a vehicle.

According to several aspects, a vehicle near-field communication card and key system includes a near-field communication (NFC) card having a chip positioned on or embedded within a face of the NFC card. An L-shaped recess is created in the face of the NFC card. An L-shaped physical grooved key is provided for the NFC card releasably and frictionally retaining the physical grooved key in the recess. The physical grooved key includes: a key portion having a first width equaling a first portion width of a first portion of the recess; and a manual grip portion having a second width equaling a second portion width of a second portion of the recess. Data of the NFC card is saved in and transmitted from the chip using a wireless transmission path to a vehicle.

In another aspect of the present disclosure, the manual grip portion and the key portion of the physical grooved key have an equivalent thickness.

In another aspect of the present disclosure, the thickness substantially matches a depth of the recess.

In another aspect of the present disclosure, the thickness is one of greater than and less than a depth of recess.

In another aspect of the present disclosure, a substantially flat or planar inner surface is created for an extent of the recess, including both the first portion and the second portion of the recess, having the physical grooved key releasably retained in direct contact with the planar inner surface.

In another aspect of the present disclosure, an outward directed face of the physical grooved key is aligned substantially even with the face of the NFC card when the physical grooved key is received in the recess.

In another aspect of the present disclosure, a height of the physical grooved key matches a total height of the recess.

According to several aspects, a method to releasably retain a physical grooved key in a near-field communication card comprises: forming a recess in a face of a near-field communication (NFC) card, having the recess substantially equal to a shape and size of a physical grooved key; aligning the physical grooved key with the recess, with a manual grip portion of the physical grooved key aligned with a first portion of the recess and a key portion of the physical grooved key aligned with a second portion of the recess; and pressing the physical grooved key into the recess to releasably fix the physical grooved key in the recess by frictional contact between the physical grooved key and opposed walls of the recess.

In another aspect of the present disclosure, the method further includes separating the physical grooved key from the recess of the NFC card by inserting an object into a concave-shaped slot positioned proximate a free end of the slot where the physical grooved key contacts the NFC card.

In another aspect of the present disclosure, the method further includes: separating the physical grooved key from the recess of the NFC card by inserting an object into an aperture oppositely located from an opening into the NFC card recess; and applying an insertion force into the aperture to displace the physical grooved key out of the recess.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a top plan view of an NFC card according to an exemplary aspect;

FIG. 2 is a side elevational view of the NFC card of FIG. 1;

FIG. 3 is a top plan view of the NFC card of FIG. 1 modified to incorporate an L-shaped recess;

FIG. 4 is a cross-sectional side elevational view taken at section 4 of the NFC card of FIG. 3;

FIG. 5 is a top plan view of a physical grooved key adapted to be frictionally and releasably retained within the recess of FIG. 3;

FIG. 6 is a side elevational view of the physical grooved key of FIG. 5;

FIG. 7 is a top plan assembly view of the NFC card of FIG. 3 following insertion of and releasably retention of the physical grooved key of FIG. 5;

FIG. 8 is a side elevational view of the assembly of FIG. 7;

FIG. 9 is a top plan view assembly view of a modified NFC card having a side-loaded physical grooved key; and

FIG. 10 is a side elevational view of the modified NFC card of FIG. 9.

### DETAILED DESCRIPTION

The following description is merely exemplary in nature and is not intended to limit the present disclosure, application, or uses.

When a component, element or layer is referred to as being “on”, “engaged to”, “connected to”, or “coupled to” another element or layer, it may be directly on, engaged, connected or coupled to the other component, element, or layer, or intervening elements or layers may be present. In contrast, when an element is referred to as being “directly on”, “directly engaged to”, “directly connected to”, or “directly coupled to” another element or layer, there may be in intervening elements or layers present. Other words used to describe the relationship between elements should be interpreted in a like fashion, such as “between” versus “directly between”, “adjacent” versus “directly adjacent”, and the like. As used herein, the term “and/or” and “one or both” include any and all combinations of one or more of the associated listed items. Further words used to describe the relationship between elements including “substantially” should be interpreted to indicate a relationship defining an entirety of, or a great or a significant extent of.

Referring to FIG. 1, a near-field communication (NFC) card and key system 10 provides an NFC card 12 together with a physical grooved key described in greater detail in reference to FIGS. 5 through 8 herein. The technology of the NFC card 12 allows devices like NFC cards, keychain fobs, smart phones and smartwatches to exchange bits of data with other devices and to read data saved on a chip 14 positioned on or embedded within a front face 16 of the NFC card 12 over short distances for example to access a vehicle 18 such as a sedan, a sport utility vehicle, a truck, a van, an autonomous driving vehicle, and a battery electric vehicle (BEV). The technology used by the chip 14 of the NFC card 12 is similar to radio-frequency identification (RFID) commonly used in security cards and keychain fobs. Data of the NFC card 12 is saved in and transmitted from the chip 14 using a wireless transmission path 20 to the vehicle 18.

The chip 14 of the NFC card and key system 10 of the present disclosure may include an individual device such as a processor, or a software component, collectively referred to as the chip 14. The chip 14 is a non-generalized, electronic control device having a preprogrammed digital controller or processor, memory or non-transitory computer readable medium used to store data such as control logic, software applications, instructions, computer code, data, lookup tables, etc., and a transceiver or input/output ports. The computer readable medium includes any type of medium capable of being accessed by a computer, such as read only memory (ROM), random access memory (RAM), a hard disk drive, a compact disc (CD), a digital video disc (DVD), or any other type of memory. The non-transitory computer readable medium excludes wired, wireless, optical, or other communication links that transport transitory electrical or other signals. The non-transitory computer readable medium includes media where data can be permanently stored and media where data can be stored and later overwritten, such as a rewritable optical disc or an erasable memory device. Computer code includes any type of program code, including source code, object code, and executable code.

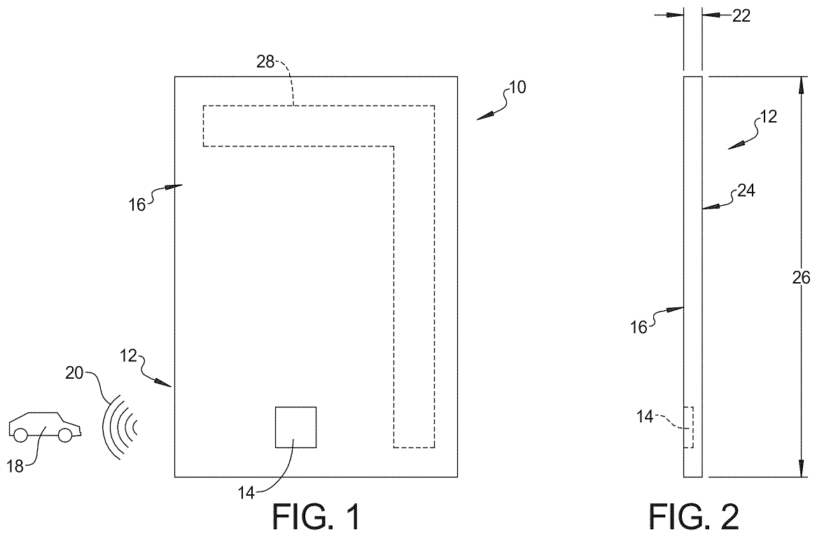

Referring to FIG. 2 and again to FIG. 1, the NFC card 12 may be thin to allow storing the NFC card 12 in a wallet, purse or pocket of a user of the vehicle 18. A thickness 22 of the NFC card 12 may therefore approximate the thickness of a credit card or similar item. A rear face 24 is substantially flat and substantially parallel with the front face 16. A height 26 or the NFC card 12 is substantially similar to a height of a common credit card or similar item. According to several aspects, the chip 14 may be embedded in the front face 16, or alternately may be embedded in the rear face 24 at the discretion of the designer or manufacturer of the NFC card 12.

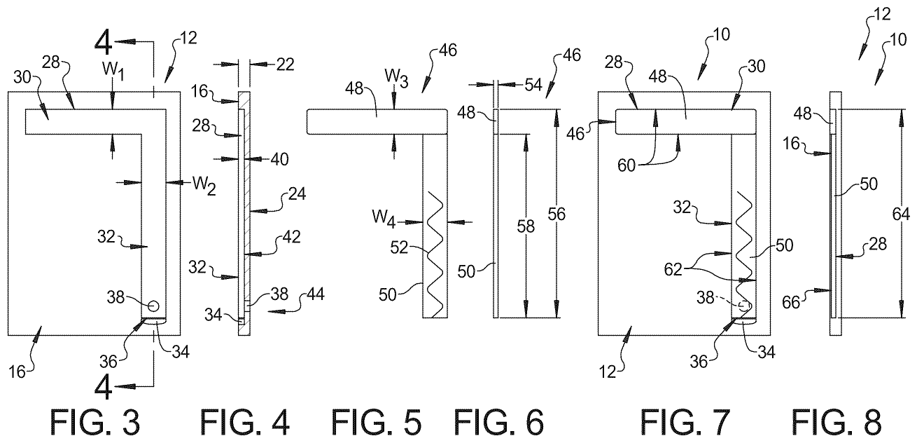

Referring to FIG. 3 and again to FIGS. 1 and 2, according to several aspects, the NFC card 12 is modified to include a slot defining a recess 28 created for example in the front face 16 of the NFC card 12. The recess 28 may be L-shaped, with a first portion 30 having a first width W₁ and a second portion 32 having a second width W₂. According to several aspects, the first width W₁ is substantially equal to the second width W₂. According to further aspects, the first width W₁ may vary from the second width W₂. A concave-shaped slot 34 may be positioned proximate to a free-end 36 of the second portion 32, whose function is described in greater detail with respect to FIG. 7. According to several aspects, an aperture 38 may be provided proximate to the free-end 38, which opens entirely through a thickness of the NFC card 12, and whose function is described in greater detail in reference to FIG. 7.

Referring to FIG. 4 and again to FIG. 3, a depth 40 of the recess 28 is less than the thickness 22 of the NFC card 12. A substantially flat or planar inner surface 42 is created for an extent of the recess 28, including both the first portion 30 and the second portion 32, directly upon which a physical grooved key shown and described in reference to FIG. 5 contacts and is releasably retained. The depth 40 also applies to a deepest portion of the concave-shaped slot 34. The aperture 38 freely opens to the rear face 24, providing access for insertion of a tool (not shown) to enter in an application direction 44.

Referring to FIG. 5 and again to FIGS. 3 and 4, according to several aspects a physical grooved key 46 is provided for the NFC card 12. The physical grooved key 46 is L-shaped to match the geometry of the L-shaped recess 28 shown and described in reference to FIG. 3. The physical grooved key 46 includes a manual grip portion 48 having a width W₃ which substantially matches the first width W₁ of the first portion 30 of the recess 28, to be frictionally and releasably received within the first portion 30. The manual grip portion 48 provides a surface area allowing the user to frictionally grip the physical grooved key 46 and to rotate the physical grooved key 46. The physical grooved key 46 also includes a key portion 50 having a grooved segment 52 defining a key geometry adapted to engage and lock or unlock door lock or to engage and operate a start feature of the vehicle 18 shown and described in reference to FIG. 1. The key portion 50 is oriented substantially 90 degrees or at a right angle with respect to the manual grip portion 48. In addition, the key portion 50 has a width W₄, which is substantially equal to the second width W₂ such that the key portion 50 may be frictionally and releasably received within the second portion 32 of the recess 28.

Referring to FIG. 6 and again to FIGS. 3 through 5, the manual grip portion 48 and the key portion 50 of the physical grooved key 46 have an equivalent thickness 54. The thickness 54 substantially matches the depth 40 of the recess 28. According to further aspects, the thickness 54 may be greater than or less than the depth 40 of recess 28 to allow for manufacturing tolerances. According to several aspects the physical grooved key 46 has a total height 56 comprising a length 58 of the key portion 50 plus the width W₃ of the manual grip portion 48.

Referring to FIG. 7, the physical grooved key 46 is shown in a stored, frictionally retained position within recess 28. An exemplary methodology used to insert the physical grooved key 46 into the recess 28 is to align the physical grooved key 46 with the recess 28 formed in the front face 16 of the NFC card 12. The physical grooved key 46 is aligned with the recess 28, with the recess 28 being substantially equal to a shape and size of the physical grooved key 46. The manual grip portion 48 is aligned with the first portion 30 and the key portion 50 is aligned with the second portion 32 of the recess 28. To releasably fix the physical grooved key 46 within recess 28, the user firmly presses the physical grooved key 46 into the NFC card recess 22. After this, the physical grooved key 46 is releasably fixed inside the NFC card recess 28, for example by frictional contact. Frictional retention of the physical grooved key 46 within the recess 28 is provided by physical contact resulting in frictional engagement between the grip portion 48 and opposed first walls 60 of the first portion 30 of the recess 28, and by frictional engagement between the key portion 50 and opposed second walls 62 of the second portion 32 of the recess 28.

An exemplary methodology for separating the physical grooved key 46 from the recess 28 of the NFC card 12 is to insert an object such as but not limited to a fingernail of the user into the concave-shaped slot 34 positioned proximate the free end 36 of the slot 28 for example along an edge where the physical grooved key 46 and the NFC card 12 meet, or to insert a small object such as a nail or a pin into the aperture 38 oppositely located from an opening into the NFC card recess 28. The user then applies a leverage force into the concave-shaped slot 34 or an insertion force into the aperture 38 to displace the physical grooved key 46 out of the NFC card recess 28, allowing the user to for example use the physical grooved key 46 to lock or unlock a vehicle door of or to operate the vehicle 18.

Referring to FIG. 8 and again to FIG. 7, the height 56 of the physical grooved key 46 also matches a total height 60 of the recess 28, or alternately the height 56 may be greater than or less than the total height 64 of recess 28. According to several aspects, to mitigate against unintended release of the physical grooved key 46 when the physical grooved key 46 is received in the recess 28, an outward directed face 66 of the physical grooved key 46 is aligned substantially even or flush with the front face 16 of the NFC card 12.

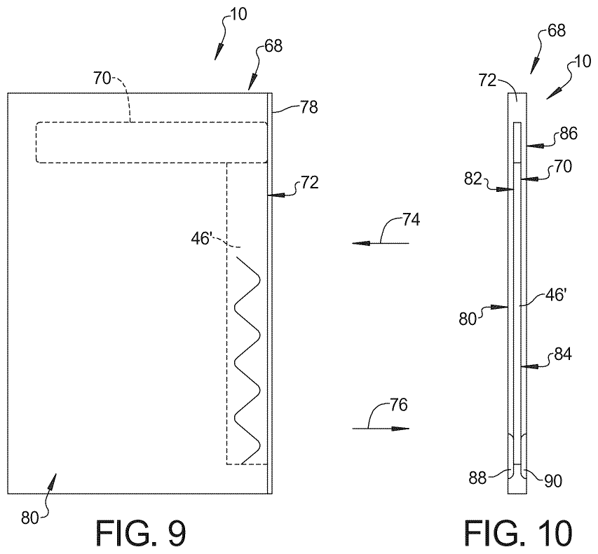

Referring to FIG. 9 and again to FIGS. 7 and 8, an NFC card 68 is modified from the NFC card 12 to provide an embedded recess 70 located on an exemplary edge 72 of the key car 68 which slidably receives a physical grooved key 46′, for example by sliding the physical grooved key 46′ into the embedded recess 70 in an insertion direction 74. The physical grooved key 46′ may be slidably removed from the embedded recess 70 in a removal direction 76 opposite to the insertion direction 74. According to several aspects, a removable tab 78 such as an adhesively attached member may be applied over the edge 72 after loading the physical grooved key 46′ to releasably retain the physical grooved key 46′. The removable tab 78 may for example be peeled off to allow removal of the physical grooved key 46′ from within the embedded recess 70. The embedded recess 70 is located beneath outer faces of the NFC card 68 such as a first outer face 80.

Referring to FIG. 10 and again to FIG. 9, the physical grooved key 46′ is shown in an inserted condition within the embedded recess 70. A first face 82 of the physical grooved key 46′ is positioned beneath the first outer face 80 and a second face 84 of the physical grooved key 46′ is positioned beneath a second outer face 86. The physical grooved key 46′ in a stowed position shown may be flush or even with the edge 72 and may be accessed for removal using a first curve-shaped slot 88 similar to the concave-shaped slot 34 shown and described in reference to FIG. 3 created in the first outer face 80. According to several aspects, a second curve-shaped slot 90 may be created in the second outer face 86 and oppositely positioned with respect to the first curve-shaped slot 88 to assist in removal of the physical grooved key 46′ from the embedded recess 70.

The NFC card 12 design of the present disclosure modifies a shape of a standard NFC card to allow for storage of a physical grooved key 46 in the same packaging space of the NFC card 12. The NFC card 12 is provided with a recess 28 in an NFC card front face 16 that defines a negative space equivalent to a space of the physical grooved key 46. The physical grooved key 46 is pressed into the recess 28 to releasably fix the physical grooved key 46 using a friction fit between the physical grooved key 46 and edges of the recess 28 formed in the NFC card 12. The frictional fit ensures the physical grooved key 46 does not become detached from the NFC card 12 except when the user intentionally applies a separating force. According to several aspects the physical grooved key 46 may be used to access the vehicle 18 described in reference to FIG. 1 when there is no voltage such as no 12V DC voltage supplied, and is shaped such that the physical grooved key 46 is thinner than the NFC card 12.

An NFC card and key system 10 of the present disclosure offers several advantages. These include combining a packaging space of an NFC card having a chip 14 with a space of a physical grooved key 46 by providing a negative space defining the recess 28 in the NFC card 12, opposite the shape of the physical grooved key 46, to receive and releasably retain the physical grooved key 46. A shape of the NFC card 12 allows for the NFC card 12 which is larger than a space required for an NFC chip 14, to also contain the physical grooved key 46. This shape allows for storage of two different components in the same package, reducing complexity of items for a user to keep track of, in direct contrast with the status quo which requires these objects to be separated, or in some cases linked by a keychain or another connective apparatus.

What is claimed is:

1. A near-field communication card and key system, comprising:
a near-field communication (NFC) card having a chip positioned on or embedded within a face of the NFC card;
a recess created in the face of the NFC card; and
a physical grooved key provided for the NFC card having:
a manual grip portion frictionally and releasably received within the recess; and
a key portion having a grooved segment defining a key geometry adapted to engage and lock or unlock a vehicle door lock of a vehicle, the key portion frictionally and releasably received within the recess.

2. The near-field communication card and key system of claim 1, wherein the recess is L-shaped, with a first portion having a first width W₁ and a second portion having a second width W₂; and wherein the first width W₁ is substantially equal to the second width W₂.

3. The near-field communication card and key system of claim 2, further including a concave-shaped slot positioned proximate to a free-end of the second portion.

4. The near-field communication card and key system of claim 2, further including an aperture provided proximate to a free-end of the second portion, the aperture extending through a thickness of the NFC card.

5. The near-field communication card and key system of claim 2, wherein a depth of the recess is less than a thickness of the NFC card, and wherein a planar inner surface is created for an extent of the recess, including the first portion and the second portion.

6. The near-field communication card and key system of claim 2, wherein the physical grooved key includes a manual grip portion having a width W₃ substantially equaling the first width W₁ of the first portion of the recess, the manual grip portion frictionally and releasably received within the first portion of the recess.

7. The near-field communication card and key system of claim 6, wherein the physical grooved key includes a key portion having a width W₄, substantially equaling the second width W₂ of the second portion of the recess, the key portion frictionally and releasably received within the second portion of the recess.

8. The near-field communication card and key system of claim 7, wherein the grooved segment defines a key geometry adapted to engage and lock or unlock a vehicle door or to engage and operate a start feature of a vehicle.

9. The near-field communication card and key system of claim 1, wherein the key portion is oriented substantially 90 degrees with respect to the manual grip portion together defining an L-shape, the key portion and the manual grip portion having an equivalent thickness, the thickness substantially equaling a depth of the recess, and the recess having an L-shape matching the L-shape of the key portion and the manual grip portion.

10. The near-field communication card and key system of claim 1, wherein data of the NFC card is saved in and transmitted from the chip using a wireless transmission path to a vehicle.

11. A vehicle near-field communication card and key system, comprising:
a near-field communication (NFC) card having a chip positioned on or embedded within a face of the NFC card;
an L-shaped recess created in the face of the NFC card; and
an L-shaped physical grooved key provided for the NFC card releasably and frictionally retained in the recess, the physical grooved key having:
a key portion having a first width equaling a first portion width of a first portion of the recess; and
a manual grip portion having a second width equaling a second portion width of a second portion of the recess; and
wherein data of the NFC card is saved in and transmitted from the chip using a wireless transmission path to a vehicle.

12. The vehicle near-field communication card and key system of claim 11, wherein the manual grip portion and the key portion of the physical grooved key have an equivalent thickness.

13. The vehicle near-field communication card and key system of claim 12, wherein the thickness substantially matches a depth of the recess.

14. The vehicle near-field communication card and key system of claim 12, wherein the thickness is one of greater than and less than a depth of recess.

15. The vehicle near-field communication card and key system of claim 11, including a substantially flat or planar inner surface created for an extent of the recess, including both the first portion and the second portion of the recess, having the physical grooved key releasably retained in direct contact with the planar inner surface.

16. The vehicle near-field communication card and key system of claim 11, wherein a height of the physical grooved key matches a total height of the recess.

17. The vehicle near-field communication card and key system of claim 11, wherein when the physical grooved key is received in the recess, an outward directed face of the physical grooved key is aligned substantially even with the face of the NFC card.

18. A method to releasably retain a physical grooved key in a near-field communication card, comprising:
forming a recess in a face of a near-field communication (NFC) card, having the recess substantially equal to a shape and size of a physical grooved key;
aligning the physical grooved key with the recess, with a manual grip portion of the physical grooved key aligned with a first portion of the recess and a key portion of the physical grooved key aligned with a second portion of the recess; and
pressing the physical grooved key into the recess to releasably fix the physical grooved key in the recess by frictional contact between the physical grooved key and opposed walls of the recess.

19. The method of claim 18, further including separating the physical grooved key from the recess of the NFC card by inserting an object into a concave-shaped slot positioned proximate a free end of the slot where the physical grooved key contacts the NFC card.

20. The method of claim 18, further including separating the physical grooved key from the recess of the NFC card by inserting an object into an aperture oppositely located from an opening into the NFC card recess, and applying an insertion force into the aperture to displace the physical grooved key out of the recess.
